(19) United States
(12) Patent Application Publication
(10) Pub. No.: US 2022/0067095 A1
(43) Pub. Date: Mar. 3, 2022

(54) SCRIPT-SEARCH OPERATIONS FOR IDENTIFYING SCRIPTS IN A SCRIPT REPOSITORY

(71) Applicant: MICROSOFT TECHNOLOGY LICENSING, LLC, Redmond, WA (US)

(72) Inventors: Gergely Z. KOTA, Kirkland, WA (US); Jesse A. FREITAS, Seattle, WA (US); Lexa HALL, Seattle, WA (US)

(21) Appl. No.: 17/005,025

(22) Filed: Aug. 27, 2020

(51) Int. Cl. G06F 16/908; G06F 16/9032; G06F 9/30; G06F 8/36

(52) U.S. Cl. CPC G06F 16/908; G06F 8/36; G06F 9/3017; G06F 16/90328

(57) ABSTRACT

Methods, systems, and computer storage media for searching, ranking, and recommending script samples using an integrated script-search system that includes programmatically defined script-search operations that are associated with action query-data for intelligent structured and immersive searching of a script repository. The action query-data specifically includes recorded actions of an automation function, where the recorded actions are captured and transformed into action query-data. The action query-data is communicated to an integrated script-search service to cause identification of script search results data including script samples from the script repository. The sample scripts in the repository are stored with metadata and action data associated with a programming language of the application, which support matching the script samples based on the action query-data. Based on the script search results data, integrated script search system functionality can be performed via an interface of the application including providing a relevant sample script as a search result.

### BACKGROUND

Users rely on script repositories for searching and identifying different types of scripts (i.e., automation tools) and script tutorials for automation tools on client computing devices. A script repository, such as a storage for scripts and script tutorials, manages resources, using script-search systems and operations, for identifying sample scripts based on user search queries. For example, a script repository provides categorical organization, search functionality, and descriptions of different types of scripts to improve user access to script samples. Conventional script-search systems and operations are limited in their ability to provide support for integrated and quick-search identification of scripts that are relevant to a particular script language and functionality. For example, a conventional script repository searching requires significant manual effort on the part of the user to define search terms and further identify relevant scripts from the script repository. As automation tools in applications continue to support functionality on clients for users, improving script repository search operations for identifying scripts can result in more effective and efficient application functionality.

### SUMMARY

Various aspects of the technology described herein are generally directed to systems, methods, and computer storage media, for among other things, searching, ranking, and recommending script samples using an integrated script-search system that includes programmatically-defined script-search operations based on action query-data. The action query-data specifically includes recorded actions of an automation function, where the recorded actions are captured and transformed into action query-data. The action query-data is communicated to an integrated script-search service to cause identification of script search results data including script samples from the script repository. The sample scripts in the repository are stored with metadata and action-query data associated with a programming language of the application, which support matching the script samples based on the action query-data. Based on the script search results data, integrated script search system functionality can be performed via an interface of the application including providing a relevant sample script as a search result. The script-search operations and action query-data allow for intelligent, structured, and immersive application-based searching of a script repository.

In operation, a set of actions that define an automation function are recorded at an application. For example, the set of actions support performing the application function that can be generated as part of an automation tool in a scripting language of the application. The set of actions are used to generate action query-data. The action query-data is communicated to an integrated script-search service associated with a script repository to cause identification of script search results data in the script repository. The script search results data, comprising one or more script samples associated with the automation function, are provided via an integrated script-search interface of the application. The application supports an integrated script-search system using integrated script-search system operations (“script-search operations”) of an integrated script search system associated with an application, the integrated script search system is configured to operate with the script repository. In particular, the integrated script-search system includes an integrated script-search system engine (client-side and server-side) that processes action query-data associated with an automation tool of the application (e.g., an application automation tool in a scripting language) to execute searching, ranking, and recommending relevant scripts for an automation function of the application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 is a block diagram of an exemplary integrated script-search system environment for providing script-search operations based on action query-data in an integrated script-search system, suitable for use in implementing aspects of the technology described herein;

FIGS. 2A-2E is an exemplary integrated script-search system environment for providing script-search operations based on action query-data in an integrated script-search system, in accordance with aspects of the technology described herein;

FIG. 3 provides a first exemplary method of providing script-search operations based on action query-data in an integrated script-search system in accordance with aspects of the technology described herein;

FIG. 4 provides a second exemplary method of providing script-search operations based on action query-data in an integrated script-search system, in accordance with aspects of the technology described herein;

FIG. 5 provides a third exemplary method of providing script-search operations based on action query-data in an integrated script-search system, in accordance with aspects of the technology described herein;

FIG. 6 provides a block diagram of an exemplary system environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview of Technical Problems, Technical Solutions, and Technological Improvements

Automation tools (e.g., scripts) help users build automation for tasks that would otherwise be handled manually in computing applications and services. For example, a spreadsheet application may include support for automation of spreadsheet functionality using different scripting languages. Often, users need assistance using these automation tools to develop automation for tasks, and often rely on script samples or tutorials found in script repositories. A script repository, such as a storage for scripts for different types of scripting languages, manages resources, using script-search systems and operations, for identifying sample scripts based on user search queries. For example, a script repository provides categorical organization, search functionality, and description of different types of scripts to improve user access to script samples. Searching of a script repository can be based on providing search terms that are executed against a search index of sample scripts. Executing the search identifies sample scripts that are relevant to the search terms. Script repositories can in some context include a set of sample scripts provided as part of an application that supports automation tools.

Conventional script-search systems and operations are limited in their ability to provide support for integrated and quick search and identification of scripts that are relevant to a particular script language and functionality. For example, conventional script repository searching requires significant manual effort on the part of the user to define search terms and further identify relevant scripts from the script repository. A user is forced to describe the type of script being searched, using natural language, with the user often guessing at the best terms, or ways to combine terms, as such script-search systems are unable to identify sample scripts that meet the needs of the user. Moreover, even when the user identifies the correct terms, the sample script search results can be irrelevant. The sample script search results are irrelevant because the script repository stores scripts in different scripting language or user-defined terms (e.g., variables, application programming interfaces (APIs), as such, the identified search results are irrelevant to the user when they match the search terms, but the script is in a different scripting language.

Additionally, most search repositories operate as websites that take the user out of the application experience into a separate search interface for identifying sample scripts. The user can further be expected to download and install any relevant search results manually, which can get tedious, when multiple sample script search results are identified. As scripted functionality in applications continue to support functionality on clients for users, improving script repository search operations for identifying scripts can result in more effective and efficient application functionality. As such, a comprehensive integrated script-search system with an alternative basis for performing script-search operations can improve computing operations and interface remove the limitations associated with conventional search of sample scripts.

Embodiments of the present invention are directed to simple and efficient methods, systems, and computer storage media for searching, ranking, and recommending script samples using integrated script-search system operations (“script-search operations”) of an integrated script search system associated with an application, the integrated script search system is configured to operate with a script repository. The integrated script-search system includes programmatically defined script-search operations that are associated with action query-data for intelligent structured and immersive searching of a script repository. In particular, the integrated script-search system includes an integrated script-search system engine (client-side and server-side) that processes action query-data associated with an automation tool of the application (e.g., an application automation tool in a scripting language) to execute searching, ranking, and recommending scripts for an automation function of the application. The action query-data specifically includes recorded actions of the automation function, where the recorded actions are captured and transformed into action query-data. The action query-data is communicated to an integrated script-search service to cause identification of script search results data including script samples from the script repository. Based on the script search results data, additional integrated script search system functionality can be performed via an interface of the application including providing a selected sample script as a search result.

In operation, a set of actions that define an automation function are recorded at an application. The application supports an integrated script-search system. For example, the set of actions support performing the application function that can be generated as part of an automation tool in a scripting language of the application. The set of actions are used to generate action query-data. The action query-data is communicated to an integrated script-search service associated with a script repository to cause identification of script search results data in the script repository. The script search results data, comprising one or more script samples associated with the automation function, are provided via an integrated script-search interface of the application.

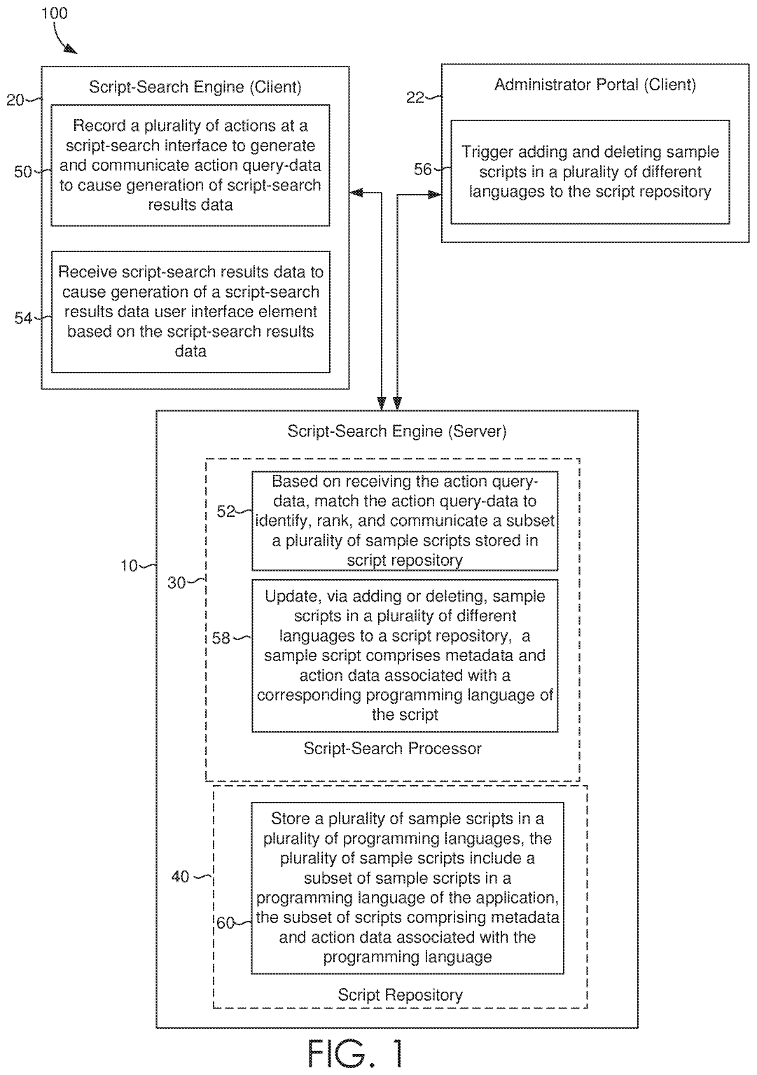

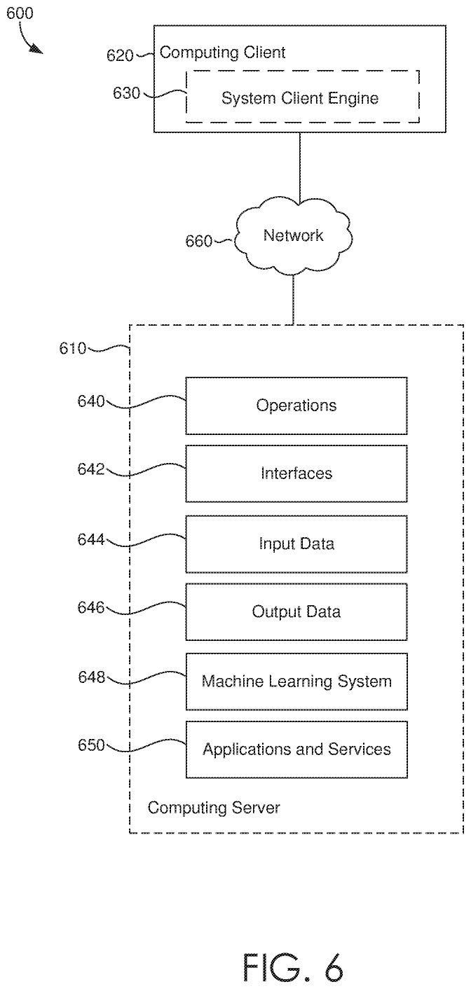

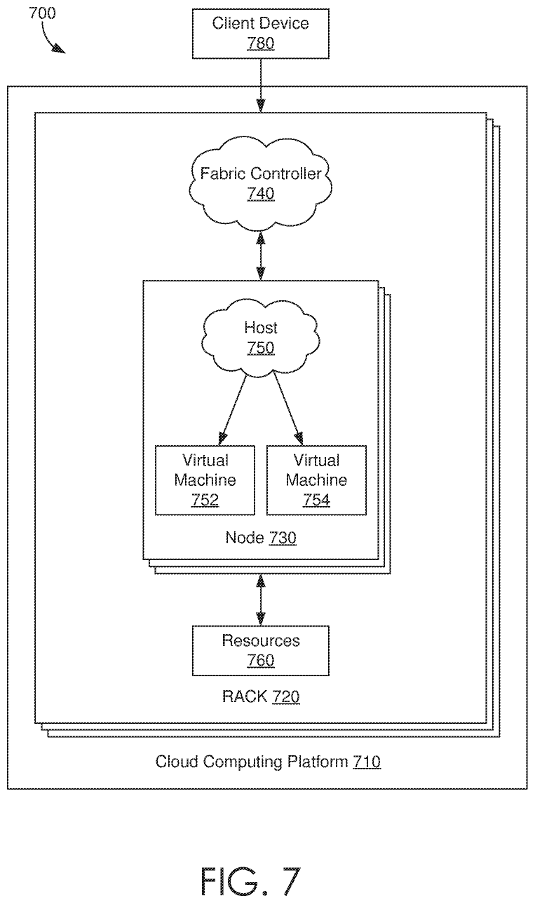

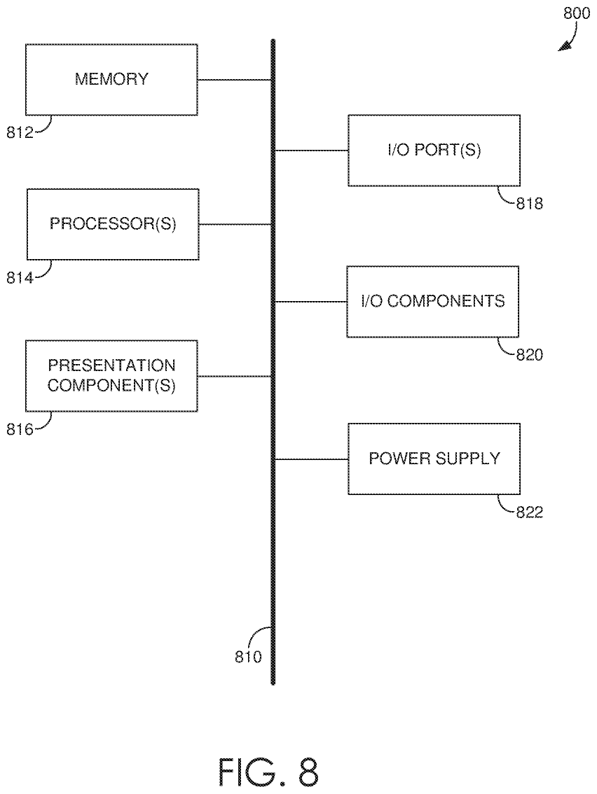

Aspects of the technical solution can be described by way of examples and with reference to FIG. 1. FIG. 1 illustrates an integrated script-search system 100 having an integrated script-search system engine (server) “script-search engine” 10 and an integrated script-search system engine (client) “script-search engine” 20. The integrated script-search system 100 also includes an administrator portal 22, script-search processor 30, script repository 40. The integrated script-search system provides and performs improved integrated script-search systems search operations and interfaces to support the functionality of technical solution in a technical solution environment having components described herein with reference to FIG. 6, FIG. 7 and FIG. 8.

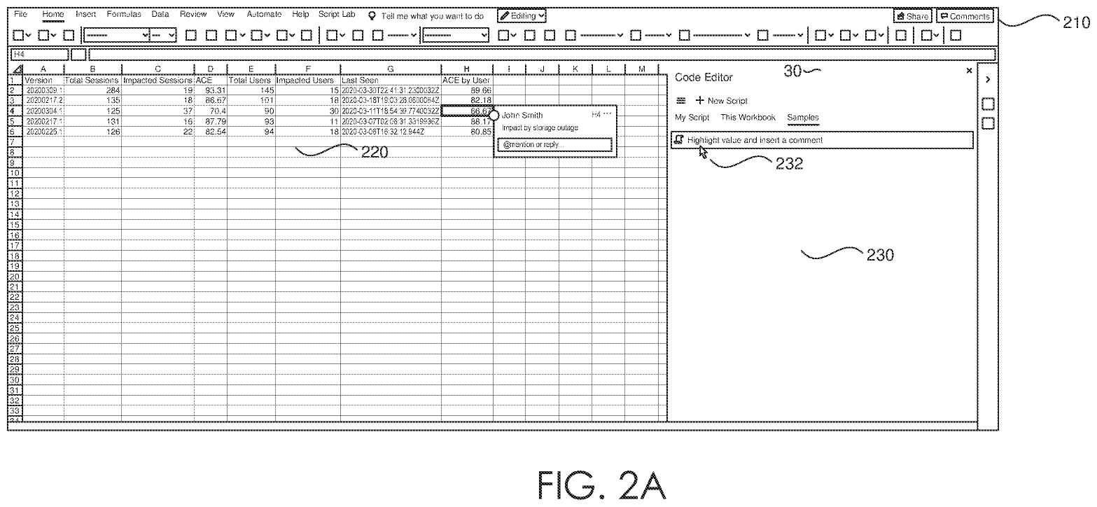

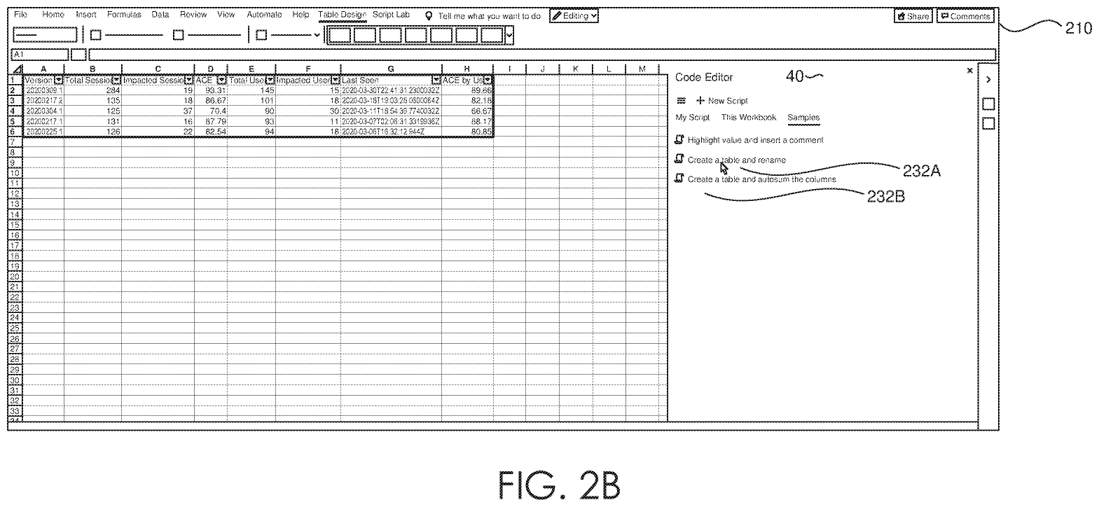

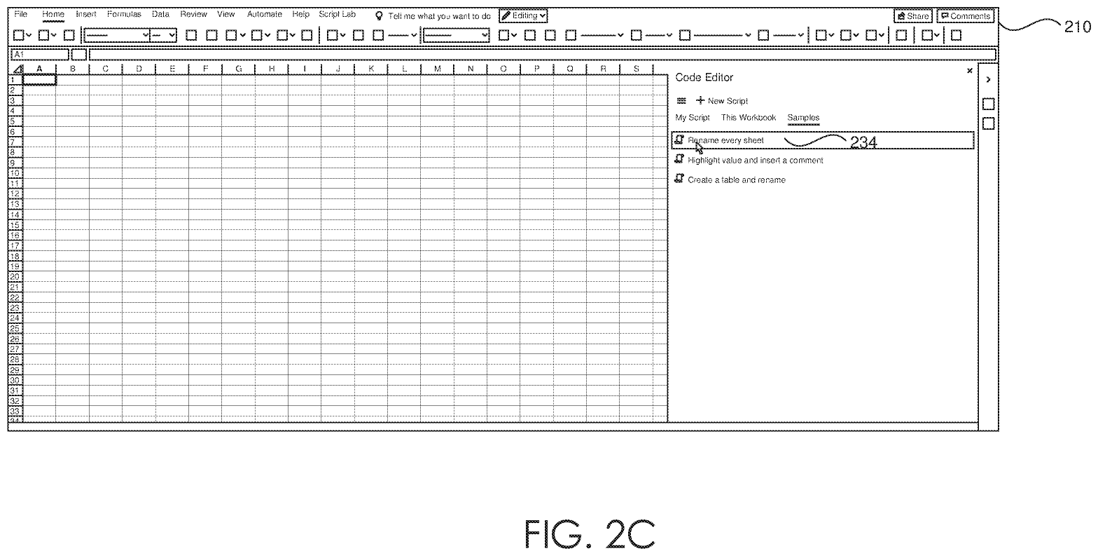

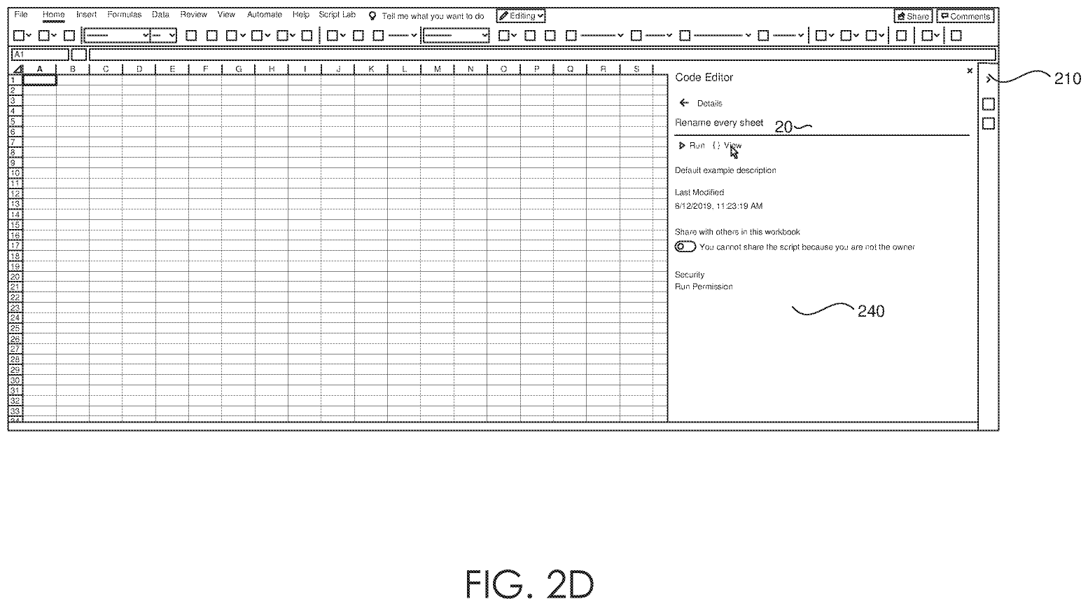

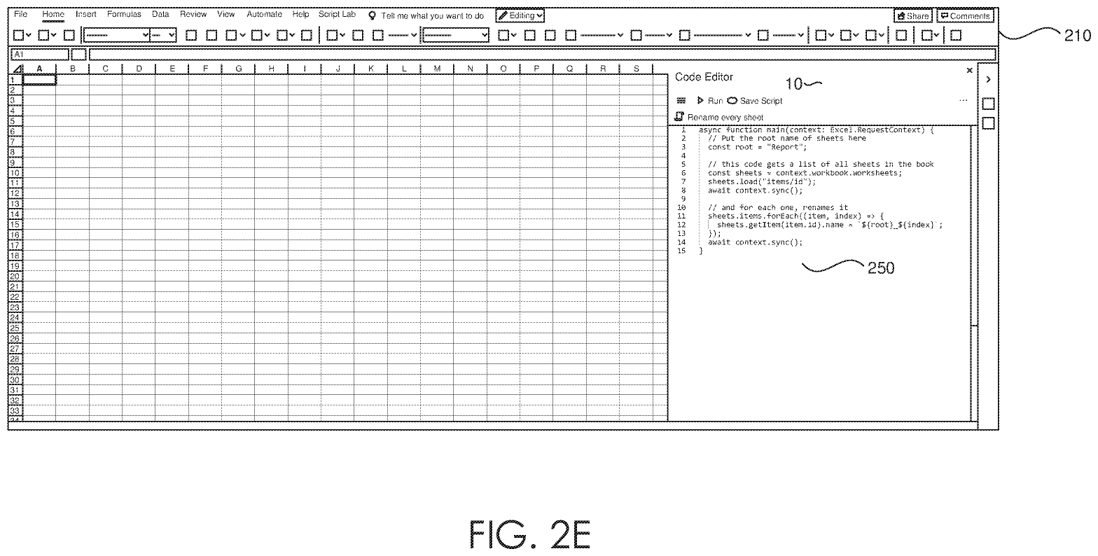

Turning to FIGS. 2A-2E, FIGS. 2A-2E are example interfaces that support providing search-script operations based on action query-data in an integrated script-search system as described herein. FIG. 2A includes an application 210 (e.g., a spreadsheet or workbook application). The application 210 includes a data interface 220 an integrated script-search interface 230 that supports recording the actions of the application function at the application. The application function is written in a programming language (i.e., scripting language) supported by the application 210. The integrated script-search interface 220 can be include a code editor that is operationally coupled to the script-search functionality of the application. The application can support different types of programming languages with either or both application associated with the integrated script-search functionality.

The integrated script-search interface can be accessed to record a plurality of actions entered by the user. The plurality of action are associated with performing an application tasks. For example, a user may enter a sequence of actions to for different application functions (e.g., “create table” and “rename sheet”), and each action in the sequence of actions are recorded. The sequence of actions are associated with performing a task (or automating application functionality) for which the user wants additional sample scripts or tutorials (e.g., from a script repository). Based on the user performing the sequence of actions (i.e., the plurality of actions) the sequence of actions are recorded. For example, with continued reference to FIG. 2A, the user may perform a highlight and comment action 232 which is recorded and provide in the integrated script-search interface 2430. In FIG. 2B, the user has performed another action that is recorded as two additional actions (i.e., create at table 232A and crate a table and auto-sum the columns 232B). In FIG. 2C, the user has performed another action that is recorded as a rename every sheet action 234. As shown, the type of action performed can change the presentation of the recording of the action in the code editor of the integrated script-search interface 220.

In FIG. 2D, the user may elect to view an operations view 240 of the sequence of actions recorded, where from the operations view 240 the user may elect to run the recorded sequence of action of view the sequence of action. In FIG. 2E, the user has elected to view the code details of the rename every sheet action 234 such that a code view 250 of the rename every sheet action 234 is provided. Operationally, the sequence of actions are recorded to create action query-data associated with sequence of actions (or task, or application function). It is contemplated that the action query-data is generated to programmatically identify in the action query-data a programming language format associated with the application function in a programming language of the application. The programming language format can include semantics and syntax of the programming language that are maintained to support matching the action query-data to sample scripts. For example, the programming language format in the action query-data are used to identify sample scripts in the script repository that match the application function, the matching sample scripts are in the programming language format. The generated action query-data is communicated to an integrated script-search service associated with a script repository, to cause generation of script-search results data, as discussed in more detail below.

At step 50, as discussed, the script-search engine (client) supports recording a plurality of action at a script-search interface to generate communicate action query-data to cause generation of script-search results data. At step 52, the script-search processor 30 supports, based on receiving the action query, matching the action query-data to identify, rank, and communicate a subset of a plurality of sample scripts store at the script repository 60. Operationally, matching the action query-data to a set of sample scripts in the script repository supports identifying a plurality of sample scripts based on corresponding match scores. Different matching algorithms (e.g., cosine similarity, graph matching) can be used to match the sample scripts including metadata and action data of the sample scripts to the action query-data. Based on the match scores, the script-search processor 30 is responsible for ranking the plurality of sample scripts to identify a subset of the plurality of sample scripts as script-search results data. It is contemplated that the script-search results data can include additional information (e.g., matching features, no match found, and missing information) that is generated at the script-search processor 30 based on performing the matching and ranking operations. The search results data comprising the subset of the plurality of sample scripts is communicated to the script-search engine 20.

At step 54, the script-search engine 20 is responsible for receiving the script-search results data to cause generation of a script-search results data user interface element based on the script-search results data. The can be configured to only selectively present script-search results data. In particular, causing display of a sample script in the search result data based on the sample script meeting a relevance threshold relative to the action query-data. For example, even though script-search results data is identified, the sample scripts may not match the action query-data up to a defined relevance threshold, the matched samples scripts may not be relevant to the application function. As discussed, script-search results data can further include different types results information include the matched action data and metadata can be selectively provided via the integrated script-service interface using one or more script-search results data user interface elements.

At step 56, administrator portal 22 on an administrator client is generated to provide interfaces (e.g., graphical user interfaces) that support adding and deleting sample scripts. Sample scripts can be in different programming languages to support different applications. For example, a first application may support a first programming language, a second programming language, and a third language. A second application may support only third programming language. Sample scripts are added with metadata and action data associated with a corresponding programming language of the script such that the metadata and action data support integrated script-search via applications that support the corresponding programming languages. At step 58, the script-search processor is configured to support updating, via adding or deleting, sample scripts in a plurality of different languages to a script repository. And at step 60, the script repository 40 operates as a store for a plurality of sample scripts in a plurality of programming languages. The plurality of sample scripts include a subset of sample scripts in a programming language of an application integrated script-search functionality as described herein.

Functionality of the embodiments of the present invention have further been described, by way of an implementation and anecdotal examples, to demonstrate that the operations for providing script-search operations, based on action query-data, are an unconventional ordered combination of operations that operate with a deployment engine as a solution to a specific problem in integrated script-search systems technology environments to improve computing operations and user interface navigation in integrated script-search systems. Advantageously, the embodiments described herein improve the computing operations, functionality, and the technological process for providing the functionality described herein. Overall, these improvements result in increased flexibility in script-searching and management.

### Overview of Example Environments for Providing Script-Search Operations Based on Action Query-Data in an Integrated Script-Search System

With reference to FIG. 1, a block diagram of an exemplary technical solution environment, based on example environments described with reference to FIGS. 6, 7 and 9, for use in implementing embodiments of the technical solution are shown. Generally the technical solution environment includes a technical solution system suitable for providing the example integrated script-search system 100 in which methods of the present disclosure may be employed. In particular, FIG. 1 shows a high level architecture of the integrated script-search system 100 in accordance with implementations of the present disclosure. Among other engines, managers, generators, selectors, or components not shown (collectively referred to herein as “components”), the technical solution environment of 1 illustrates an integrated script-search system 100 having an integrated script-search system engine (server) “script-search engine” 10 and an integrated script-search system engine (client) “script-search engine” 20. The integrated script-search system 100 also includes an administrator portal 22, script-search processor 30, and script repository 40. The components of the integrated script-search system 100 support searching, ranking, and recommending script samples using integrated script-search system.

### Exemplary Methods for Providing Script-Search Operations Based on Action Query-Data in an Integrated Script-Search System

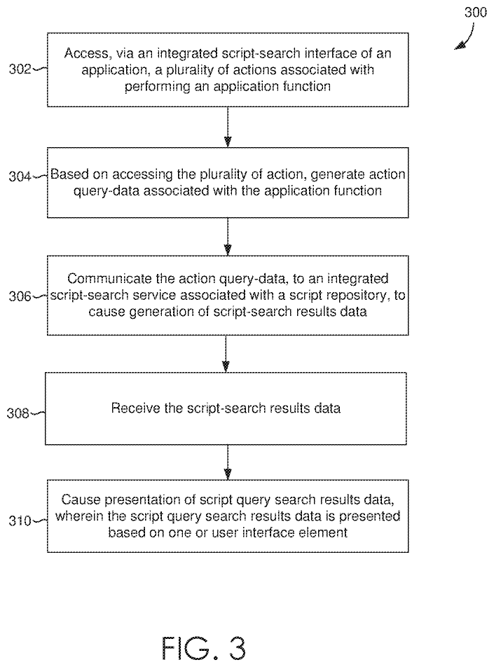

With reference to FIGS. 3, 4 and 5, flow diagrams are provided illustrating methods for script-search operations based on action query-data in an integrated script-search system. The methods may be performed using the search system described herein. In embodiments, one or more computer storage media having computer-executable instructions embodied thereon that, when executed, by one or more processors can cause the one or more processors to perform the methods in the file system.

Turning to FIG. 3, a flow diagram is provided that illustrates a method 300 for providing script-search operations based on action query-data in an integrated script-search system. At block 302, access, via an integrated script-search interface of an application, a plurality of actions associated with performing an application function. The integrated script-search interface supports recording the plurality of actions of the application function at the application. The application function is written in a programming language supported by the application.

At block 304, based on accessing the plurality of action, generate action query-data associated with the application function. Generating the action query-data comprises programmatically identifying in the action query-data a programming language format associated with the application function in a programming language of the application. The programming language format in the action query-data are used to identify sample scripts in the script repository that match the application function, wherein matching sample scripts are in the programming language form.

At block 306, communicate the action query-data, to an integrated script-search service associated with a script repository, to cause generation of script-search results data. At block 308, receive the script-search results data. At block 310, cause presentation of script query search results data, the script query search results data is presented based on one or user interface element.

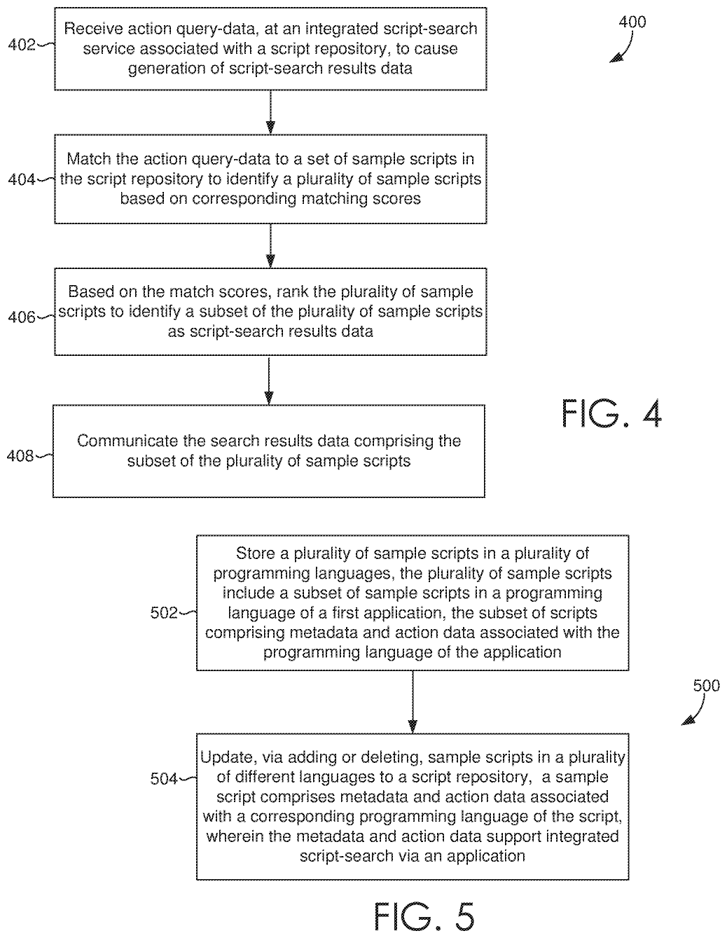

Turning to FIG. 4, a flow diagram is provided that illustrates a method 400 for providing script-search operations based on action query-data in a integrated script-search system. At block 402, Receive action query-data, at an integrated script-search service associated with a script repository, to cause generation of script-search results data. At block 404, Match the action query-data to a set of sample scripts in the script repository to identify a plurality of sample scripts based on corresponding matching scores. At block 406, based on the match scores, rank the plurality of sample scripts to identify a subset of the plurality of sample scripts as script-search results data. At block 408, communicate the search results data comprising the subset of the plurality of sample scripts.

Turning to FIG. 5, a flow diagram is provided that illustrates a method 500 providing script-search operations based on action query-data in an integrated script-search system. At block 502, store a plurality of sample scripts in a plurality of programming languages. The plurality of sample scripts include a subset of sample scripts in a programming language of a first application. The subset of scripts comprising metadata and action data associated with the programming language of the application.

At block 504, update, via adding or deleting, sample scripts in a plurality of different languages to a script repository. A sample script comprises metadata and action data associated with a corresponding programming language of the script. The metadata and action data support integrated script-search via an application

### Example System Environment

With reference to FIG. 6, FIG. 6 illustrates an example system environment 600 in which implementations of the technical solution may be employed. In particular, FIG. 6 illustrates a client-server environment that includes computing server 610 and computing client 620 having a system client engine that can mirror components in the computing server 610. The computing server 610 includes operations 640, interfaces 642, input data 644, output data 646, machine learning engine 648, and application and service 650 that are part of a technical solution environment to support the technical solution described herein. The components of the technical solution environment can be integrated components that include a hardware architecture and a software framework that support constraint computing and/or constraint querying functionality within a technical solution system. The hardware architecture refers to physical components and interrelationships thereof, and the software framework refers to software providing functionality that can be implemented with hardware embodied on a device.

The end-to-end software-based system can operate within the system components to operate computer hardware to provide system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the system components can manage resources and provide services for system functionality. Any other variations and combinations thereof are contemplated with embodiments of the present invention.

By way of example, the technical solution system can include an API library that includes specifications for routines, data structures, object classes, and variables may support the interaction between the hardware architecture of the device and the software framework of the technical solution system. These APIs include configuration specifications for the technical solution system such that the different components therein can communicate with each other in the technical solution system, as described herein.

The technical solution system can further include a machine learning system. A machine-learning system may include machine-learning tools and training components. Machine-learning systems can include machine-learning tools that are utilized to perform operations in different types of technology fields. Machine-learning systems can include pre-trained machine-learning tools that can further be trained for a particular task or technological field. At a high level, machine-learning is a field of study that gives computers the ability to learn without being explicitly programmed. Machine-learning explores the study and construction of machine-learning tools, including machine-learning algorithm or models, which may learn from existing data and make predictions about new data. Such machine-learning tools operate by building a model from example training data in order to make data-driven predictions or decisions expressed as outputs or assessments. Although example embodiments are presented with respect to a few machine-learning tools, the principles presented herein may be applied to other machine-learning tools. It is contemplated that different machine-learning tools may be used, for example, Logistic Regression (LR), Naive-Bayes, Random Forest (RF), neural networks (NN), matrix factorization, and Support Vector Machines (SVM) tools may be used for addressing problems in different technological fields.

In general, there are two types of problems in machine-learning: classification problems and regression problems. Classification problems, also referred to as categorization problems, aim at classifying items into one of several category values (for example, is this email SPAM or not SPAM). Regression algorithms aim at quantifying some items (for example, by providing a value that is a real number). Machine-learning algorithms can provide a score (e.g., a number from 1 to 100) to qualify one or more products as a match for a user of the online marketplace. It is contemplated that cluster analysis or clustering can be performed as part of classification, where clustering refers to the task of grouping a set of objects in such a way that objects in the same group (called a cluster) are more similar (in some sense) to each other than to those in other groups (clusters). It is a main task of exploratory data mining, and a common technique for statistical data analysis, used in many fields, including pattern recognition, image analysis, information retrieval, bioinformatics, data compression, computer graphics and machine learning.

Machine-learning algorithms utilize the training data to find correlations among identified features (or combinations of features) that affect an outcome. A trained machine-learning model may be implemented to perform a machine-learning operation based on a combinations of features. An administrator of a machine-learning system may also determine which of the various combinations of features are relevant (e.g., lead to desired results), and which ones are not. The combinations of features determined to be (e.g., classified as) successful are input into a machine-learning algorithm for the machine-learning algorithm to learn which combinations of features (also referred to as “patterns”) are “relevant” and which patterns are “irrelevant.” The machine-learning algorithms utilize features for analyzing the data to generate an output or an assessment. A feature can be an individual measurable property of a phenomenon being observed. The concept of feature is related to that of an explanatory variable used in statistical techniques such as linear regression. Choosing informative, discriminating, and independent features is important for effective operation of the machine-learning system in pattern recognition, classification, and regression. Features may be of different types, such as numeric, strings, and graphs.

The machine-learning algorithms utilize the training data to find correlations among the identified features that affect the outcome or assessment. The training data includes known data for one or more identified features and one or more outcomes. With the training data and the identified features the machine-learning tool is trained. The machine-learning tool determines the relevance of the features as they correlate to the training data. The result of the training is the trained machine-learning model. When the machine-learning model is used to perform an assessment, new data is provided as an input to the trained machine-learning model, and the machine-learning model generates the assessment as output.

### Example Distributed Computing System Environment

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Distributed Computing Environment

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-usable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-usable instructions that, when used by the one or more computer processors, cause the one or more computer processors to perform operations comprising:
accessing, via an integrated script-search interface of an application, a plurality of actions associated with performing an application function;
based on accessing the plurality of actions, generating action query-data associated with the application function; and
communicating the action query-data, to an integrated script-search service associated with a script repository, to cause generation of script-search results data;
receiving the script-search results data; and
based on receiving the script-search results data, causing generation of a script-search results data interface element using the integrated script-search interface.

2. The system of claim 1, wherein the integrated script-search interface supports recording the plurality of actions of the application function at the application, wherein the application function is written in a programming language supported by the application.

3. The system of claim 1, wherein generating the action query-data comprises programmatically identifying in the action query-data a programming language format associated with the application function in a programming language of the application, wherein the programming language format in the action query-data are used to identify sample scripts in the script repository that match the application function, wherein matching sample scripts are in the programming language format.

4. The system of claim 1, wherein the script repository operates as a store for a plurality of sample scripts in a plurality of programming languages, wherein the plurality of sample scripts include a subset of sample scripts in a programming language of the application, wherein the subset of sample scripts comprise metadata and action data associated with the programming language of the application.

5. The system of claim 3, the operations further comprising, the integrated script-search service configured for:
matching the action query-data to a set of sample scripts in the script repository to identify a plurality of sample scripts based on corresponding match scores;
based on the match scores, ranking the plurality of sample scripts to identify a subset of the plurality of sample scripts as script-search results data; and
communicating the search results data comprising the subset of the plurality of sample scripts.

6. The system of claim 1, wherein causing display of a sample script in the search result data is based on the sample script meeting a relevance threshold relative to the action query-data.

7. The system of claim 1, the operations further comprising, the integrated script-search service configured for adding and deleting sample scripts in a plurality of different languages to the script repository, wherein a sample script comprises metadata and action data associated with a corresponding programming language of the script, wherein the metadata and action data support integrated script-search via an application.

8. One or more computer-storage media having computer-executable instructions embodied thereon that, when executed by a computing system having a processor and memory, cause the processor to:
accessing, via an integrated script-search interface of an application, a plurality of actions associated with performing an application function;
based on accessing the plurality of actions, generating action query-data associated with the application function; and
communicating the action query-data, to an integrated script-search service associated with a script repository, to cause generation of script-search results data;
receiving the script-search results data; and
based on receiving the script-search results data, causing generation of a script-search results data interface element using the integrated script-search interface.

9. The media of claim 8, wherein the integrated script-search interface supports recording the plurality of actions of the application function at the application, wherein the application function is written in a programming language supported by the application.

10. The media of claim 8, wherein generating the action query-data comprises programmatically identifying in the action query-data a programming language format associated with the application function in a programming language of the application, wherein the programming language format in the action query-data are used to identify sample scripts in the script repository that match the application function, wherein matching sample scripts are in the programming language format.

11. The media of claim 8, wherein the script repository operates as a store for a plurality of sample scripts in a plurality of programming languages, wherein the plurality of sample scripts include a subset of sample scripts in a programming language of the application, wherein the subset of sample scripts comprise metadata and action data associated with the programming language of the application.

12. The media of claim 8, the operations further comprising, the integrated script-search service configured for:
matching the action query-data to a set of sample scripts in the script repository to identify a plurality of sample scripts based on corresponding match scores;
based on the match scores, ranking the plurality of sample scripts to identify a subset of the plurality of sample scripts as script-search results data; and
communicating the search results data comprising the subset of the plurality of sample scripts.

13. The media of claim 8, wherein causing display of a sample script in the search result data is based on the sample script meeting a relevance threshold relative to the action query-data.

14. The media of claim 8, the operations further comprising, the integrated script-search service configured for adding and deleting sample scripts in a plurality of different languages to the script repository, wherein a sample script comprises metadata and action data associated with a corresponding programming language of the script, wherein the metadata and action data support integrated script-search via an application.

15. A computer-implemented method, the method comprising:
accessing, via an integrated script-search interface of an application, a plurality of actions associated with performing an application function;
based on accessing the plurality of actions, generating action query-data associated with the application function; and
communicating the action query-data, to an integrated script-search service associated with a script repository, to cause generation of script-search results data;
receiving the script-search results data; and
based on receiving the script-search results data, causing generation of a script-search results data interface element using the integrated script-search interface.

16. The method of claim 15, wherein the integrated script-search interface supports recording the plurality of actions of the application function at the application, wherein the application function is written in a programming language supported by the application.

17. The method of claim 15, wherein generating the action query-data comprises programmatically identifying in the action query-data a programming language format associated with the application function in a programming language of the application, wherein the programming language format in the action query-data are used to identify sample scripts in the script repository that match the application function, wherein matching sample scripts are in the programming language format.

18. The method of claim 15, wherein the script repository operates as a store for a plurality of sample scripts in a plurality of programming languages, wherein the plurality of sample scripts include a subset of sample scripts in a programming language of the application, wherein the subset of sample scripts comprise metadata and action data associated with the programming language of the application.

19. The method of claim 15, the operations further comprising, the integrated script-search service configured for:
matching the action query-data to a set of sample scripts in the script repository to identify a plurality of sample scripts based on corresponding match scores;
based on the match scores, ranking the plurality of sample scripts to identify a subset of the plurality of sample scripts as script-search results data; and
communicating the search results data comprising the subset of the plurality of sample scripts.

20. The method of claim 15, wherein causing display of a sample script in the search result data is based on the sample script meeting a relevance threshold relative to the action query-data.
